(19) United States
(12) Patent Application Publication
(10) Pub. No.: US 2025/0094406 A1
(43) Pub. Date: Mar. 20, 2025

(54) System and Method for Ingesting Data onto Cloud Computing Environments

(71) Applicant: The Toronto-Dominion Bank, Toronto (CA)

(72) Inventors: Leyden MARTINEZ FONTE, Oakville (CA); Shweta Girish MUMGAI, Toronto (CA); Prathibha MUDIYALA, Chesterfield, NJ (US); Lin LIU, Richmond Hill (CA); Subramanyam Venkata CHAKRALA, Markham (CA); Sridhara Krishna SAMUDRALAVENKATANARASIMHAMALIKARJUNA, Markham (CA)

(73) Assignee: The Toronto-Dominion Bank, Toronto (CA)

(21) Appl. No.: 18/470,060

(22) Filed: Sep. 19, 2023

(51) Int. Cl. G06F 16/23; G06F 16/11

(52) U.S. Cl. CPC G06F 16/2365; G06F 16/116

(57) ABSTRACT

A system, device and method are provided for ingesting data onto cloud computing environments. The illustrative method includes providing an accelerator in a cloud computing environment for ingestion of data into the cloud computing environment. The method includes automatically, with the accelerator (1) verifying that one or more templates defining ingestion parameters are populated on the cloud computing environment, (2) verifying that resources in a target destination in the cloud computing environment have been provisioned, (3) populating, based on the one or more templates, and with a pipeline of tasks, one or more configuration reference destinations for transforming raw data into a format compatible with the provisioned target destination. The method includes ingesting a data file into the verified target destination in the cloud computing environment based on the verified one or more templates and populated configuration reference destinations.

### TECHNICAL FIELD

The following relates generally to ingesting data into cloud computing systems.

### BACKGROUND

Increasingly, events in various facets of everyday life are being digitized. This increased digitization has been accompanied by an increased adoption of cloud computing services (also known as multi-tenant network environments) to store and read, write, or edit the data stored thereon.

The adoption of these cloud computing services has led to various technical challenges, including challenges associated with interfacing existing non-cloud systems (referred to in the alternative as on-premises systems) with cloud computing systems to ingest data stored on such on-premises systems.

For one, the cloud systems are increasingly relied on to not only store data, but to store data in a timely manner. Various time sensitive or real time applications can falter if the cloud infrastructure is inadequate, and designing an architecture to ingest the data with the required latency is a challenge.

In addition, and at times in part as a result of the increasing need for timely ingestion, ensuring that the ingestion process is accurate can be challenging. Not only should the correct data be ingested, but various metadata should also correctly be ingested (e.g., the location of the data, the access rights to the data, etc.) and acted upon.

Magnifying these challenges is the fact that, at least in some instances, the on-demand nature of cloud systems and increasing use thereof has made the ingestion process complex. Various computing resources need to be provisioned, the provisioning should be appropriate for the intended task, different tasks rely on common architectural components that such that often neither the owner of the task or the owner of the architecture have complete knowledge of the details of the work that needs to be done, etc. Maintaining these systems can also be challenging.

The complexity of modern cloud computing systems also increases challenges associated with coordinating the various data sources and actions associated with them. Data within the cloud system may need to be reallocated, new individuals may need to be given permission over new data sources, etc.

The sheer volume of data ingested by these systems makes it difficult to address some of the above issues by relying solely on manual processes. Conversely, any deviation from manual processes can also magnify the risks described above, as automated systems can quickly propagate errors.

Any implementation to address the above technical issues is also further complicated by the requirement that it be a scalable, extensible, and robust solution, able to facilitate accurate and timely ingestion for a variety of use cases (e.g., various services provided by a large institution).

### BRIEF DESCRIPTION OF THE DRAWINGS

Embodiments will now be described with reference to the appended drawings wherein:

FIG. 1 is a schematic diagram of an example computing environment.

FIG. 2 shows a block diagram of an example configuration of an ingestion accelerator according to the disclosure herein.

FIG. 3 shows a block diagram of an example configuration of a cloud computing platform.

FIG. 4 shows a block diagram of an example configuration of an enterprise platform.

FIG. 5 shows a block diagram of an example configuration of a user device.

FIG. 6 shows a flow diagram of an example method performed by computer executable instructions for provisioning resources for ingestion.

FIG. 7 shows a flow diagram of an example method performed by computer executable instructions for ingesting data from a data source according to the disclosure herein.

FIG. 8 shows a flow diagram of an example method performed by computer executable instructions for validating ingested data.

FIG. 9 shows a flow diagram of an example method performed by computer executable instructions for ingesting data onto cloud computing environments.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

Existing ingestion systems can be time consuming to use and implement, and often rely primarily or solely on manual efforts. For example, in at least some existing systems, ingestion and validation can require up to two days in a development environment, two days in a system integration test, etc., where the overall amount of time required to ingest data can span eight to ten days. These existing systems, in at least some instances, include first ingesting the data by running an ingestion pipeline, and then validating if the data was successfully ingested, and the related metadata was correctly populated, etc. In other words, some existing approaches rely on an after-the-fact assessment, which assessment requires a costly and time consuming manual review.

The proposed approach includes an ingestion accelerator (e.g., a utility script) used during a cloud-ingestion development process that validates and/or creates and/or populates technical settings and structures in an ingestion framework. The ingestion accelerator can include various pipelines (e.g., for diverse-and-repetitive tasks), repeated for different entities (in other words: many times, within the same environment, for different sub-parts). In testing, the proposed approach with an ingestion accelerator was able to reduce the amount of time for validation to approximately one (1) hour and thirty minutes in a system integration test environment.

The disclosed ingestion accelerator can include automation of a plurality of validation tasks, increasing the reliability, scalability, and accuracy of ingestion frameworks. The ingestion accelerator can help new data engineers better understand how ingestion pipelines work (as they learn to interact with a plurality of disparate components to understand the ingestion accelerator). The ingestion accelerator can be extensible to accommodate a variety of different use cases in a large institution with large amounts of data to ingest and adapt to a variety of changes. For example, the ingestion accelerator can be updated to accommodate new types of ingestion (e.g., new application programming interfaces (APIs)), new tasks (e.g., validating new incoming data collections (IDCs) (as that term is used herein), curating new or different pipelines in the ingestion framework, repurposing pipelines for different ingestion accelerators, and more generally enabling modularity akin or open-source functionality in an enterprise platform 16, as different versions of an accelerator can be created for different practices.

In addition, in contrast to some existing systems, the disclosed ingestion accelerator can include a variety of pre-ingestion steps to ensure accuracy, removing the need to implement at least some ingestion prior to diagnosing issues in a backward manner.

The accelerator framework supports file-based, database and API-based cloud ingestions and is extensible to other types of ingestions. The accelerator framework can accelerate, scale, and streamline the process of ingesting large volumes of data into cloud-based storage systems. Additionally, the cloud ingest accelerator can significantly improve the speed and reliability of data ingestion, enabling organizations to transfer data efficiently and seamlessly to their respective cloud environments.

In one aspect, a system for ingesting data onto cloud computing environments is disclosed. The system includes a processor, a communications module coupled to the processor, and a memory coupled to the processor. The memory stores computer executable instructions that when executed by the processor cause the processor to provide an accelerator in a cloud computing environment for ingestion of data into the cloud computing environment. The instructions cause the processor to automatically, with the accelerator, (1) verify that one or more templates defining ingestion parameters are populated on the cloud computing environment, (2) verify that resources in a target destination in the CCE have been provisioned, and (3) populate, based on the one or more templates, and with a pipeline of tasks, one or more configuration reference destinations for transforming raw data into a format compatible with the provisioned target destination. The instructions cause the processor to ingest a data file into the verified target destination in the cloud computing environment based on the verified one or more templates and populated configuration reference destinations.

In example embodiments, the instructions cause the processor to compare one or more properties of a source database associated with the data file with properties in the one or more templates to identify inconsistency, and in response to determining inconsistency, prevent ingestion of the data file via a pipeline.

In example embodiments, the instructions cause the processor to generate, with another pipeline, one or more configuration files for use during ingestion, and populate for the configuration reference destinations with the generated one or more configuration files. Ingestion of the data file into the target destination can include one or more transformation steps defined by the generated one or more configuration files configuration files.

In example embodiments, the instructions cause the processor to validate that the target destination has correct access permissions to enable ingestion.

In example embodiments, the instructions cause the processor to provide an ingestion pipeline for ingesting the data file, and confirm instantiation of the ingestion pipeline prior to ingesting the data file by changing a property of the pipeline.

In example embodiments, the instructions cause the processor to, with a confirmation pipeline, compare the property of the pipeline to an expected property to assess whether the pipeline has been correctly instantiated.

In example embodiments, the instructions cause the processor to compare configuration data of a data source associated with the data file with configuration data of the ingested data file, and in response to determining the respective configurations are consistent, enable ingestion of additional data files from the data source.

In example embodiments, the instructions cause the processor to automate ingestion of additional data files associated with the data file through the pipeline. The additional data files can be ingested in real time.

In example embodiments, the data file arrives in a landing zone, and ingesting the data file into the destination resources in the cloud computing environment includes the instructions to cause the processor to with a migration pipeline, migrate the data file into an intermediate landing zone associated with the target destination. The instructions cause the processor to determine whether the migrated data file corresponds to a valid data source in a watermark table for tracking composition of the target destination, and in response to determining the migrated data file corresponds with the watermark table, enable ingestion of the data file with a transport pipeline.

In another aspect, a method for ingesting data onto cloud computing environments is disclosed. The method includes providing an accelerator in a cloud computing environment for ingestion of data into the cloud computing environment. The method includes, automatically, with the accelerator, (1) verifying that one or more templates defining ingestion parameters are populated on the cloud computing environment, (2) verifying that resources in a target destination in the cloud computing environment have been provisioned, and (3) populating, based on the one or more templates, and with a pipeline of tasks, one or more configuration reference destinations for transforming raw data into a format compatible with the provisioned target destination. The method includes ingesting a data file into the verified target destination in the cloud computing environment based on the verified one or more templates and populated configuration reference destinations.

In example embodiments, the method includes comparing configuration files in the configuration reference destinations with the templates to identify inconsistency, and in response to determining inconsistency, preventing ingestion of the data file via a pipeline.

In example embodiments, the method includes generating, with another pipeline, one or more configuration files for use during ingestion, and populating for the configuration reference destinations with the generated one or more configuration files. This these example embodiments. ingestion of the data file into the target destination includes one or more transformation steps defined by the generated one or more configuration files.

In example embodiments, the method includes providing an ingestion pipeline for ingesting the data file, and confirming instantiation of the ingestion pipeline prior to ingesting the data file by changing a property of the pipeline. The method can include, with a confirmation pipeline, comparing the property of the pipeline to an expected property to assess whether the pipeline has been correctly instantiated.

In example embodiments, the method includes comparing configuration data of a data source associated with the data file with configuration data of the ingested data file, and in response to determining the respective configurations are consistent, enabling ingestion of additional data files from the data source.

In example embodiments, the method includes automating ingestion of additional data files associated with the data file through the pipeline.

In example embodiments, the additional data files are ingested in real time.

In example embodiments, the data file arrives in a landing zone, and ingesting the data file into the destination resources in the cloud computing environment further includes with a migration pipeline, migrating the data file into an intermediate landing zone associated with the target destination. The method includes determining whether the migrated data file corresponds to a valid data source in a watermark table for tracking composition of the target destination, and in response to determining the migrated data file corresponds with the watermark table, enabling ingestion of the data file with a transport pipeline.

In another aspect, a non-transitory computer readable medium for ingesting data onto cloud computing environments is disclosed. The computer readable medium including computer executable instructions for providing an accelerator in a cloud computing environment for ingestion of data into the cloud computing environment. The computer executable instructions can be for automatically, with the accelerator, (1) verifying that one or more templates defining ingestion parameters are populated on the cloud computing environment, (2) verifying that resources in a target destination in the cloud computing environment have been provisioned, and (3) populating, based on the one or more templates, and with a pipeline of tasks, one or more configuration reference destinations for transforming raw data into a format compatible with the provisioned target destination. The computer executable instructions can include ingesting a data file into the verified target destination in the cloud computing environment based on the verified one or more templates and populated configuration reference destinations.

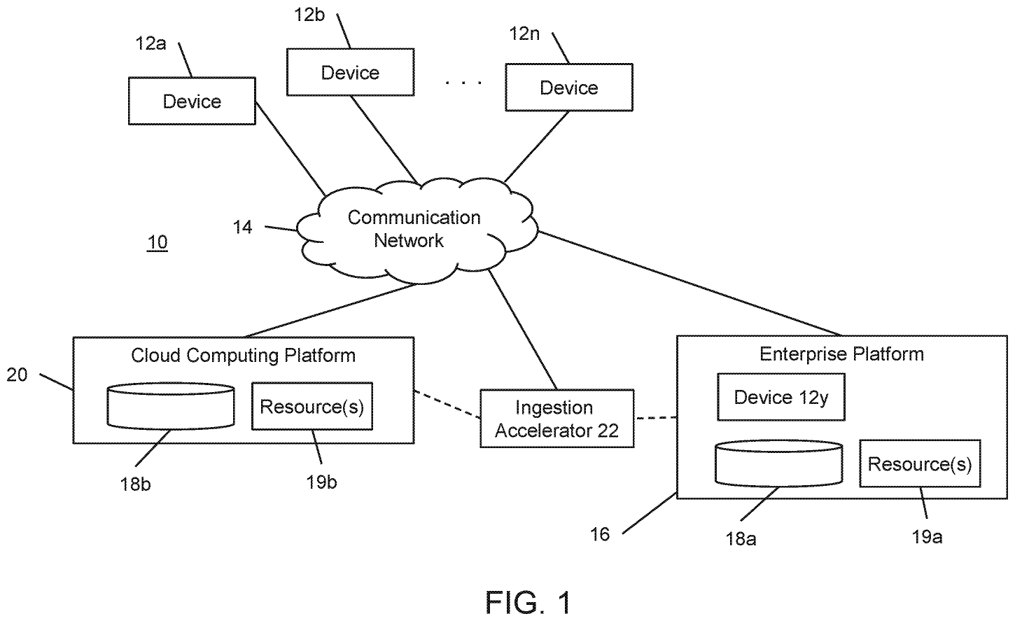

FIG. 1 illustrates an exemplary computing environment 10. The computing environment 10 can include one or more devices 12 for interacting with computing devices or elements implementing an ingestion process (as described herein), a communications network 14 connecting one or more components of the computing environment 10, an enterprise platform 16, and a cloud computing platform 20.

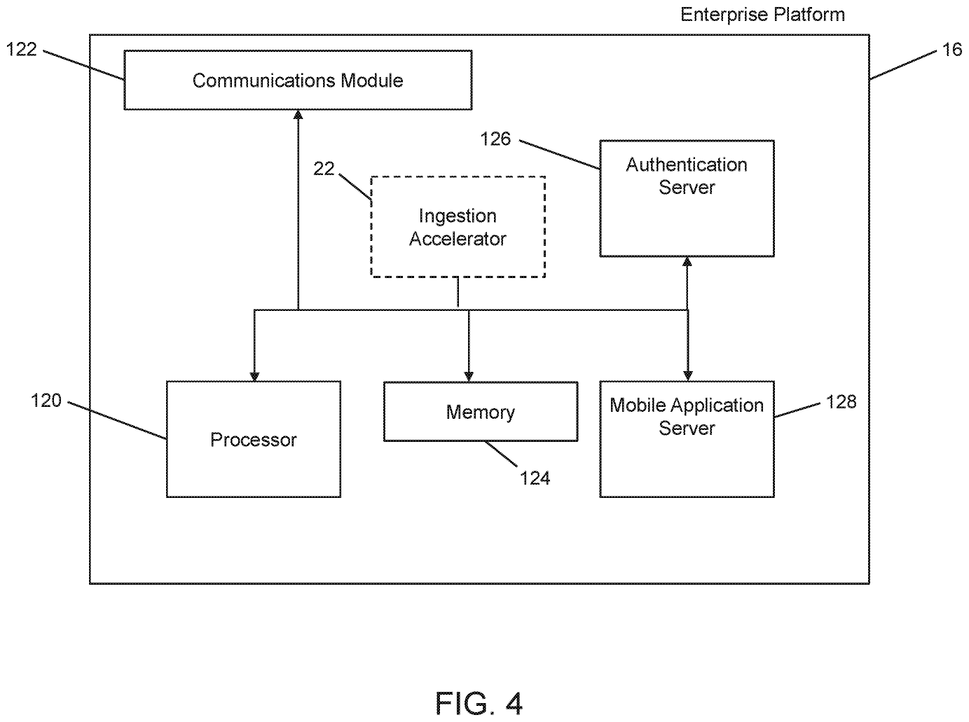

The enterprise platform 16 (e.g., a financial institution such as commercial bank and/or lender) stored data, in the shown example stored in a database 18a, that is to be ingested into the cloud computing platform 20. For example, the enterprise platform 16 can provide a plurality of services via a plurality of enterprise resources (e.g., various instances of the shown database 18a, and/or computing resources 19a). While several details of the enterprise platform 16 have been omitted for clarity of illustration, reference will be made to FIG. 4 below for additional details.

The data the enterprise platform 16 is responsible for can be at least in part sensitive data (e.g., financial data, customer data, etc.), data that is not sensitive, or a combination of the two. This disclosure contemplates an expansive definition of data that is not sensitive, including, but not limited to factual data (e.g., environmental data), data generated by an organization (e.g., monthly reports, etc.), personal data (e.g., journal entries), etc. This disclosure contemplates an expansive definition of data that is sensitive, including client data, personally identifiable information, financial information, medical information, trade secrets, confidential information, etc.

The enterprise platform 16 includes resources 19a to facilitate ingestion. For example, the enterprise platform 16 can include a communications module (e.g., module 122 of FIG. 4) to facilitate communication with the ingestion accelerator 22 or cloud computing platform 20.

The cloud computing platform 20 similarly includes one or more instances of a database 18b, for example, for receiving data to be ingested, for storing ingested data, for storing metadata such as configuration files, database 18b instances in the form of an intermediate landing zone, etc. Resources 19b of the cloud computing platform 20 can facilitate the ingestion of the data (e.g., special purpose computing hardware to perform automations described herein). The ingestion can include a variety of operations, including but not limited to transforming data, migrating data, enacting access controls, etc. Hereinafter, for ease of reference, the resources 18, 19, of the respective platform 16 or 20 shall be referred to generally as resources, unless otherwise indicated.

It can be appreciated that while the cloud computing platform 20 and enterprise platform 16 are shown as separate entities in FIG. 1, they may also be implemented, run or otherwise directed by a single enterprise. For example, the cloud computing platform 20 can be contracted by the enterprise platform 16 to provide certain functionality of the enterprise platform 16, or the enterprise platform 16 can be almost entirely on the cloud platform 20, etc.

Devices 12 may be associated with one or more users. Users may be referred to herein as customers, clients, users, investors, depositors, correspondents, or other entities that interact with the enterprise platform 16 and/or cloud computing platform 20 (directly or indirectly). The computing environment 10 may include multiple devices 12, each device 12 being associated with a separate user or associated with one or more users. The devices can be external to the enterprise system (e.g., the shown devices 12a, 12b, to 12n, with which clients provide sensitive data to the enterprise), or internal to the enterprise platform 16 (e.g., the shown device 12x, which can be controlled by a data scientist of the enterprise). In certain embodiments, a user may operate device 12 such that device 12 performs one or more processes consistent with the disclosed embodiments. For example, the user may use device 12 to generate requests to ingest certain data into the cloud computing platform 20, to transfer data from the database 18a to the cloud computing platform 20, etc.

Devices 12 can include, but are not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

Communication network 14 may include a telephone network, cellular, and/or data communication network to connect different types of devices 12. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), Wi-Fi or other similar wireless network, and a private and/or public wide area network (e.g., the Internet).

The cloud computing platform 20 and/or enterprise platform 16 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public, and private keys in a PKI), and perform other cryptographic operations that are required or desired for particular applications of the cloud computing platform 20 and enterprise platform 16. The cryptographic server may, for example, be used to protect any data of the enterprise platform 16 when in transit to the cloud computing platform 20, or within the cloud computing platform 20 (e.g., data such as financial data and/or client data and/or transaction data within the enterprise) by way of encryption for data protection, digital signatures or message digests for data integrity, and by using digital certificates to authenticate the identity of the users and devices 12 with which the enterprise platform 16 and/or cloud computing platform 20 communicates to ingest data. It can be appreciated that various cryptographic mechanisms and protocols can be chosen and implemented to suit the constraints and requirements of the particular deployment of the cloud computing platform 20 or enterprise platform 16 as is known in the art.

The system 10 includes an ingestion accelerator 22 for facilitating ingestion of data stored on the enterprise platform 16 to the cloud computing platform 20. It can be appreciated that while the ingestion accelerator 22, cloud computing platform 20 and enterprise platform 16 are shown as separate entities in FIG. 1, they may also be utilized at the direction of a single party. For example, the cloud computing platform 20 can be a service provider to the enterprise platform 16, such that resources of the cloud computing platform 20 are provided for the benefit of the enterprise platform 16. Similarly, the ingestion accelerator 22 can originate within the enterprise platform 16, as part of the cloud computing platform 20, or as a standalone system provided by a third party.

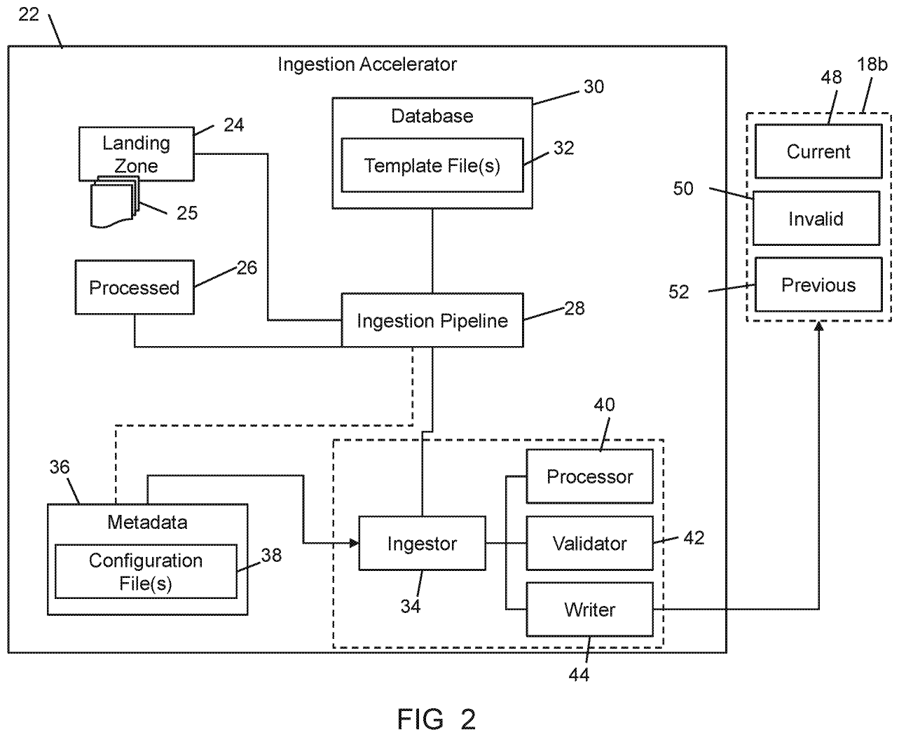

FIG. 2 shows a block diagram of an example ingestion accelerator 22. In FIG. 2, the ingestion accelerator 22 is shown as including a variety of components, such as a landing zone 24 and a processed database 26 (which can store metadata associated with migrating data from the landing zone 24). It is understood that the shown configuration is illustrative (e.g., different configurations are possible, where, for example, a plurality of landing zones 24 can be instantiated, or the landing zone 24 can be external to the ingestion accelerator 22 but within the platform 20, etc.) and is not intended to be limiting.

The landing zone 24 is for receiving data files 25 from one or more instances of the enterprise platform 16. The data files 25 can be received from the platform 16 directly (e.g., from a market research division), or indirectly (e.g., from a server of an application utilized by the enterprise platform 16, which server is remote to the enterprise platform 16), or some combination of the two. The landing zone 24 can simultaneously receive large quantities of data files 25 which include data from a plurality of data sources of the platform 16. For example, the landing zone 24 can receive New York market data from a New York operation, commodities data from an Illinois operation, etc.

The ingestion pipeline(s) 28 performs one or more operations. In example embodiments, the ingestion pipeline(s) 28 include(s) a plurality of pipelines which perform different operations. For example, an ingestion pipeline 258 can be used to transform received data files 25 into a format corresponding to the format used in the database 18b. An ingestion pipeline 28 can be used to migrate data files 25 from the landing zone 24 to an intermediate landing zone (as that term is used herein). An ingestion pipeline 28 can generate or provision the intermediate landing zone. An ingestion pipeline 28 can be a confirmation pipeline to confirm the status of a pipeline 28 used to ingest data from an intermediate landing zone to the database 18b.

At least one pipeline of the ingestion pipeline 28 can determine an appropriate ingestion pathway for data files 25 within the landing zone 24. For example, a data file 25 from a first data source (e.g., from a database 18a-1 (not shown)), can be intended to be digested into a first location of database 18b alongside other human resources information, whereas another data file 25 (e.g., from a database 18a-2 (not shown)) can be intended to be loaded into a different location for storing market information.

The ingestion pathway determined by the ingestion pipeline 28 can determine not only the final location of the ingested data, but operations used to ingest the data files 25. For example, data from the database 18a-1 may be transformed in a different manner than data from the database 18a-2.

The ingestion pipeline 28 can communicate with a template database 30 to facilitate the determination of the appropriate ingestion pathway. The template database 30 can include one or more template files 32 (hereinafter referred to in the singular, for ease of reference) that can be used to identify parameters of the data files 25 being ingested, or to progress ingestion of the data files 25. For example, the one or more template files 32 can include an IDC template file 32 used by the ingestion pipeline 28 to determine the type of data file 25 being ingested, the originating location of the data file 25, etc., as well as a mapping of processing patterns or parameters applicable to the data files 25 based on identified properties (e.g., by correlating the determined properties to a property mapping stored in an IDC template file 32). Continuing the example, if the data file 25 being ingested has properties that correlate to certain specified criteria within a particular IDC template file 32, the ingestion pipeline 28 determines that the data file 25 is to be ingested in accordance with a configuration specified by the template file 32.

In example embodiments, the template file 32 provides the format that the data file being ingested is expected to be stored in the computing resources 8 (e.g., the template file 32 identifies that data files 25 being ingested include a set of customer addresses and directs the ingestion pipeline 28 to a configuration file 38 for formatting customer address files). In example embodiments, the template file 32 can include an IDC file which stores the format that the data file being ingested is stored on the on-premises system (e.g., the template file 32 stores the original format of the data file, for redundancy).

Based on the determination, the ingestion pipeline 28 provides the data file 25 to an ingestor 34 for processing (e.g., a Databricks™ environment). In example embodiments, the ingestion pipeline 28 provides the ingestor 34 with at least some parameters from the template file 32. For example, the ingestion pipeline 28 can provide the ingestor 34 with extracted properties of the data file in a standardized format (e.g., the data file has X number of entries, etc.).

To restate, the ingestion pipeline 28 can include a plurality of pipelines, each with different operations, and can be implemented within a data factory environment (e.g., the Azure™ Data Factory) of the cloud computing platform 20.

The ingestor 34 processes the received data file based on an associated configuration file 38. In example embodiments, the ingestion pipeline 28 can provide the ingestor 34 with the location of an associated configuration file 38 for processing the data being ingested. The ingestion pipeline 28 can determine a subset of configuration files 38, and the ingestor 34 can determine the associated configuration file 38 based on the provided subset. In other example embodiments, the ingestor 34 solely determines the associated configuration file 38 based on the data file, and possibly based on information provided by the ingestion pipeline 28, if any. In example embodiments, the ingestion pipeline 28 can retrieve the associated configuration file 38 and provide the ingestor 34 with same.

The ingestor 34 retrieves the configuration file 38 from a metadata repository 36 having a plurality of metadata repositories 36. The metadata repository 36 can include configuration files 38 for processing a plurality of data files 25 from different sources, having different schemas, etc. Each configuration file 38 can be associated with a particular data file 25, or a group of related data files 25 (e.g., a configuration file 38 can be related to a stream of data files 25 originating from an application). In an example, the configuration file 38 can be in the form of a JavaScript Object Notation (JSON) configuration file, or another notation can be used as required.

The configuration file 38 can include parsing parameters, and mapping parameters. The parsing parameters can be used by the ingestor 34 to find data within the data file 25, or more generally to navigate and identify features or entries within the data file 25. The parsing parameters of the configuration file 38 can define rules an ingestor 34 uses to determine a category applicable to the data file 25 being ingested. Particularizing the example, the configuration file 38 can specify one or more parameters to identify a type of data, such as an XML file, an XSL Transformation (XSLT) or XML Schema Definition (XSD) file, etc., by, for example, parsing syntax within the received data file 25.

It is contemplated that the configuration file 38 can facilitate identification of the ingested data in a variety of ways, such as allowing for the comparison of data formats, metadata or labelling data associated with the data, value ranges, etc., of the ingested data file 25 with one or more predefined parameters.

The parsing parameters can also include parameters to facilitate extraction or manipulation of data entries into the format of the database 18a. For example, an example configuration file 38 can include parameters for identifying or determining information within a data file, such as the header/trailer, field delimiter, field name, etc. These parameters can allow the ingestor 34 to effectively parse through the data file to find data for manipulation into the standardized format, for example (e.g., field delimiters are changed).

The parsing parameters can include parameters to identify whether the data file is an incremental data file, or a complete data file. For example, where the data file is a daily snapshot of a particular on premises database, the parameters can define that the ingestor 34 should include processes to avoid storing redundant data. In the instance of the data file being a complete data file, the ingestor 34 can be configured to employ less demanding or thorough means to determine redundant data, if at all.

The mapping parameters can include one or more parameters associated with storing parsed data from the data file 25. The mapping parameters can specify a location within the database 18b into which the data file will be ingested. For example, the configuration file 38 can include or define the table name, schema, etc., used to identify the destination of the data file 25. The mapping parameters can define one or more validation parameters. For example, the mapping parameters can identify that each record has a record count property that must be validated.

The mapping parameters can include parameters defining a processing pattern for the data file 25. In one example, the mapping parameters specify that entries in a certain format are transformed into a different format. Continuing the example, the mapping parameters can identify that a data in a first data source in the format of MM/DD/YY be transformed into a date format of the target destination of DD/MM/YYYY. More generally, the mapping parameters can allow the ingestor 34 to identify or determine file properties or types (e.g., different data sets can be stored using different file properties) and parameters defining how to process the identified file property type (e.g., copy books for mainframe files, etc.).

The ingestor 34 can perform the ingestion of data files 25 for writing to database 18b with one or more modules (e.g., the shown processor 40, validator 42, and writer 44). For example, the ingestor 34 can process received data files 25 into a particular standardized format based on the configuration file 38 with the processor 40. The ingestor 34 can validate data files 25 with the validator 42 and write transformed data files 25 to the database 18b with the writer 44. Collectively, the ingestor 34 and the described modules shall hereinafter be referred to as the ingestor 34, for ease of reference. For clarity, although the ingestor 34 is shown separate from the processor 40, the validator 42, and the writer 44, it is understood that these elements may form part of the ingestor 34. That is, the processor 40, the validator 42, and the writer 44 may be implemented as libraries which the ingestor 34 has access to, to implement the functionality defined by the respective library (this is also shown visually with a broken lined box).

Data written in the database 18b can be stored as one of current data 48, invalid data 50 (e.g., data that could not be ingested), and previous data 52 (e.g., stale data).

The use of separate configuration files 38 can potentially (1) decrease the computational effort required to sort through a single large template file to determine how to ingest data, and (2) enable beneficial persistence in a location conducive to increasing the speed of ingesting the data files. However, the use of a separate configuration file also introduces potential complications: (1) there is an increased chance of error with ingestion, with multiple sources being required to complete ingestion successfully (e.g., both a template 32 and a configuration file 38), (2) the configuration files 38 and the template files 32 and other metadata may be controlled by different entities, leading to access and coordination issues, (3) making changes to configuration files 38 or other sources of reference is a complicated coordination problem involving potentially may different common architectural components, (4) increases the work needed to manually coordinate ingestion, and (5) introduces complexity to enable scaling and robustness.

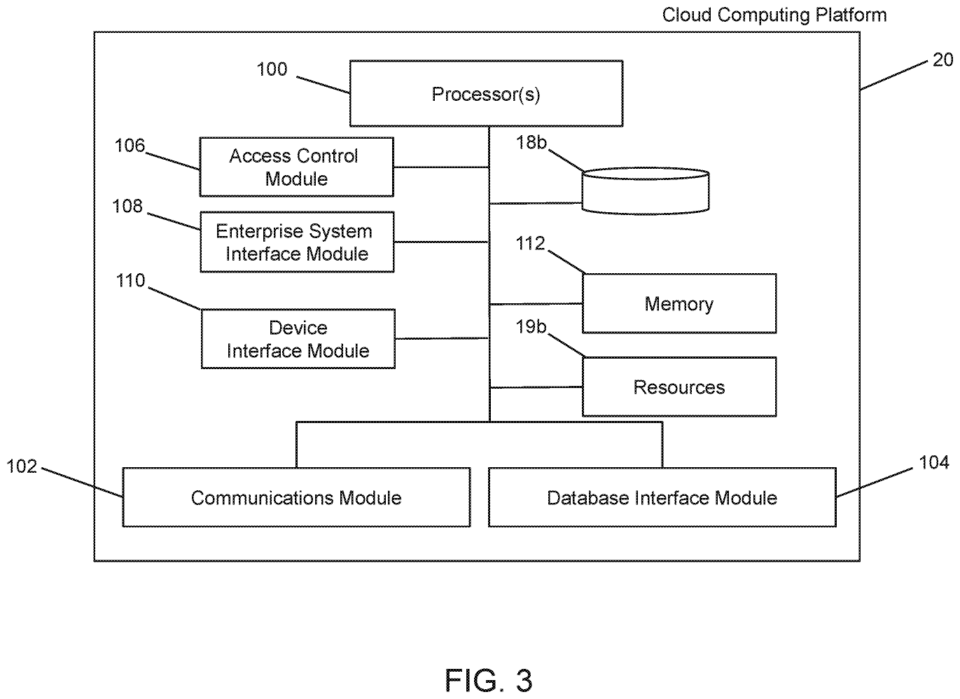

Referring now to FIG. 3, a block diagram of an example configuration of a cloud computing platform 20 is shown. FIG. 3 illustrates examples of modules, tools and engines stored in memory 112 on the cloud computing platform 20 and operated or executed by the processor 100. It can be appreciated that any of the modules, tools, and engines shown in FIG. 3 may also be hosted externally and be available to another cloud computing platform 20, e.g., via the communications module 102.

In the example embodiment shown in FIG. 3, the cloud computing platform 20 includes an access control module 106, an enterprise system interface module 108, a device interface module 110, and a database interface module 104. The access control module 106 may be used to apply a hierarchy of permission levels or otherwise apply predetermined criteria to determine what aspects of the cloud computing platform 20 can be accessed by devices 12, what resources 18b, 19b, the platform 20 can provide access to, and/or how related data can be shared with which entity in the computing environment 10. For example, the cloud computing platform 20 may grant certain employees of the enterprise platform 16 access to only certain resources 18b, 19b, but not other resources. In another example, the access control module 106 can be used to control which users are permitted to alter or provide template files 32, or configuration files 38, etc. As such, the access control module 106 can be used to control the sharing of resources 18b, 19b or aspects of the platform 20 based on a type of client/user, a permission or preference, or any other restriction imposed by the enterprise platform 16, the computing environment 10, or application in which the cloud computing platform 20 is used.

The enterprise system interface module 108 can provide a graphical user interface (GUI), software development kit (SDK) or API connectivity to communicate with the enterprise platform 16. It can be appreciated that the enterprise system interface module 108 may also provide a web browser-based interface, an application or “app” interface, a machine language interface, etc. Similarly, the device interface module 110 can provide a graphical user interface (GUI), software development kit (SDK) or API connectivity to communicate with devices 12. The database interface module 104 can facilitate direct communication with database 18a, or other instances of database 18 stored on other locations of the enterprise platform 16.

In FIG. 4, an example configuration for an enterprise platform 16 is shown. In certain embodiments, similar to the cloud computing platform 20, the enterprise platform 16 may include one or more processors 120, a communications module 122, and a database interface module (not shown) for interfacing with the remote or local datastores to retrieve, modify, and store (e.g., add) data to the resources 18a, 19a. Communications module 122 enables the enterprise platform 16 to communicate with one or more other components of the computing environment 10, such as the cloud computing platform 20 (or one of its components), via a bus or other communication network, such as the communication network 14. The enterprise platform 16 can include at least one memory or memory device 124 that can include a tangible and non-transitory computer-readable medium having stored therein computer programs, sets of instructions, code, or data to be executed by processor 120. FIG. 4 illustrates examples of modules, tools and engines stored in memory on the enterprise platform 16 and operated or executed by the processor 120. It can be appreciated that any of the modules, tools, and engines shown in FIG. 4 may also be hosted externally and be available to the enterprise platform 16, e.g., via the communications module 122. In the example embodiment shown in FIG. 4, the enterprise platform 16 includes at least part of the ingestion accelerator 22 (e.g., to automate transmission of data from the enterprise platform 16 to the cloud computing platform 20), an authentication server 126, for authenticating users to access resources 18a, 19a, of the enterprise, and a mobile application server 128 to facilitate a mobile application that can be deployed on mobile devices 12. The enterprise platform 16 can include an access control module (not shown), similar to the cloud computing platform 20.

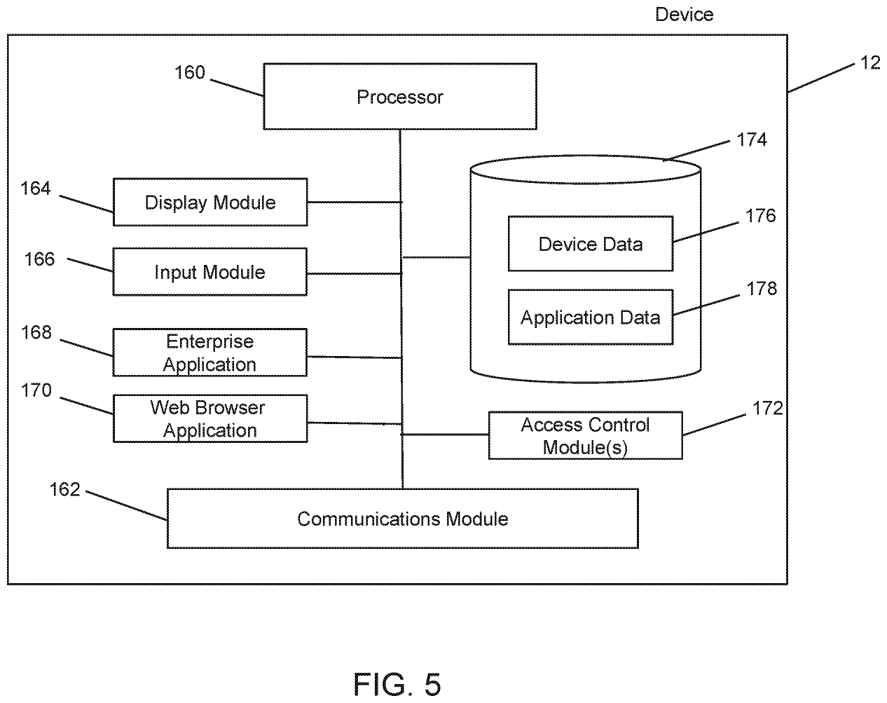

In FIG. 5, an example configuration of a device 12 is shown. In certain embodiments, the device 12 may include one or more processors 160, a communications module 162, and a data store 174 storing device data 176 (e.g., data needed to authenticate with a cloud computing platform 20 to perform ingestion), an access control module 172 similar to the access control module of FIG. 4, and application data 178 (e.g., data to enable communicating with the enterprise platform 16 to enable transferring of database 18a to the cloud computing platform 20). Communications module 162 enables the device 12 to communicate with one or more other components of the computing environment 10, such as cloud computing platform 20, or enterprise platform 16, via a bus or other communication network, such as the communication network 14. While not delineated in FIG. 5, similar to the cloud computing platform 20 the device 12 includes at least one memory or memory device that can include a tangible and non-transitory computer-readable medium having stored therein computer programs, sets of instructions, code, or data to be executed by processor 160. FIG. 5 illustrates examples of modules and applications stored in memory on the device 12 and operated by the processor 160. It can be appreciated that any of the modules and applications shown in FIG. 5 may also be hosted externally and be available to the device 12, e.g., via the communications module 162.

In the example embodiment shown in FIG. 5, the device 12 includes a display module 164 for rendering GUIs and other visual outputs on a display device such as a display screen, and an input module 166 for processing user or other inputs received at the device 12, e.g., via a touchscreen, input button, transceiver, microphone, keyboard, etc. The device 12 may also include an enterprise application 168 provided by the enterprise platform 16, e.g., for submitting requests to transfer data from the database 18a to the cloud. The device 12 in this example embodiment also includes a web browser application 170 for accessing Internet-based content, e.g., via a mobile or traditional website and one or applications (not shown) offered by the enterprise platform 16 or the cloud computing platform 20. The data store 174 may be used to store device data 176, such as, but not limited to, an IP address or a MAC address that uniquely identifies device 12 within environment 10. The data store 176 may also be used to store authentication data, such as, but not limited to, login credentials, user preferences, cryptographic data (e.g., cryptographic keys), etc.

It will be appreciated that only certain modules, applications, tools, and engines are shown in FIGS. 3 to 5 for ease of illustration and various other components would be provided and utilized by the cloud computing platform 20, enterprise platform 16, and device 12, as is known in the art.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of any of the servers or other devices in cloud computing platform 20 or enterprise platform 16, or device 12, or accessible or connectable thereto. Any application or module herein described may be implemented using computer readable/executable instructions that may be stored or otherwise held by such computer readable media.

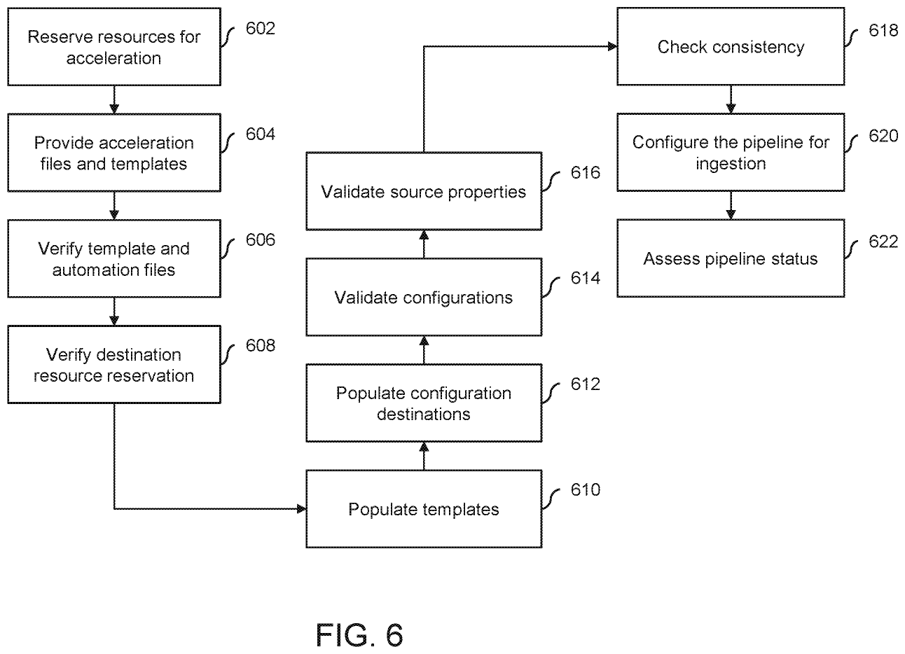

Referring to FIG. 6, a flow diagram of an example method performed by computer executable instructions for provisioning resources for ingestion is shown. It is understood that the method shown in FIG. 6 may be automatically completed in whole by the ingestion accelerator 22, or only part of the blocks shown therein may be completed automatically by the ingestion accelerator 22.

At block 602, one or more resources 18b, 19b, are reserved, and/or provisioned for accelerating ingestion of data to the cloud computing platform 20. For example, block 602 can include the creation or provisioning of a destination (e.g., a folder) in the computing resources 18b to receive configuration information related to the data files 25 to be ingested. Block 602 can include the creation of a destination for an incoming data collection (IDC) file (e.g., a manually created data file based on collaboration between data owners, data stewards, data scientists, etc.). The IDC can provide metadata for the ingestion of data files 25 into the cloud. This metadata may include the source name, file name in the database 18b (e.g., a Standardized Raw Zone (SRZ) of Azure™), a source file name pattern, etc., and in general specify at least one interrelationship between the data of database 18a being ingested and the database 18b of the cloud computing platform 20.

Block 602 can include the creation of destinations to receive data files 25. For example, block 602 can include the creation of or provisioning of landing zone(s) with an appropriate pipeline 28, such as intermediate landing zones (as described herein), for receiving data files from a data source(s). Block 602 can include the creation of a template database 30, or another repository for storing template files 32.

Block 602 can include the creation of, or the provisioning and receiving of various destinations or resources for various components of ingestion, including destination repositories for configuration files, watermark tables, etc.

Block 602 can be completed automatically via the ingestion accelerator 22, or some portions of block 602 can be completed via a manual process (e.g., generate and provision the IDF), or combination of the two, etc.

At block 604, one or more templates defining ingestion parameters are populated on the cloud computing platform 20. Populating the one or more templates can include receiving a pre-configured IDC from the platform 16. In example embodiments, block 604 includes at least in part automatically generating an IDC from other IDC instances stored on the platform 20.

Block 604 can include storing the populated templates in an intermediate landing zone generated in block 602. For example, block 602 can include the creation of an intermediate landing zone for the purposes of receiving the IDC.

Block 604 can also include (if not already provided) the provisioning of the ingestion accelerator 22 to the cloud computing platform 20. The ingestion accelerator 22 can be integrated into the template database 30, be instantiated by the creation of the plurality of pipelines 28, stored separately, etc.

At block 606, the ingestion accelerator 22 (e.g., via the ingestor 34) verifies that a template database 30 (or a target destination therein) has been provisioned. Template files 32 stored in the template database 30 can be used to generate the configuration files 38, and the lack of a template database 32 (or the lack of an appropriately addressed one) corresponding to the data files 25 to be ingested can result in erroneous data ingestion. Moreover, without the correct provisioning of the template database 30, various interconnected components and teams responsible for the ingestion can be misaligned. For example, a data scientist may rely on the template database 30 to assess what data is needed to generate an analysis data set. In another example, a data owner (e.g., a line of business (LoB)) can expect that configuration files 38 will be generated from existing template file 32, and assume that a template file 32 has been generated.

At block 608, the ingestion accelerator 22 (e.g., via the ingestor 34) verifies that resources (e.g., resources 18b, 19b) in a target destination (e.g., database 18b) of the cloud computing platform 20 have been provisioned. For example, the ingestion accelerator 22 can determine whether the target destination has appropriate access permissions, resourcing, etc. Block 608 can include determining whether the target destination itself has been initialized (e.g., the IDC specified that an additional database 18b resource at location x would be provided for new market data from a new jurisdiction, and block 608 includes verification of the existence of the expected resources at x).

At block 610, the one or more template files 32 defining ingestion parameters are populated on the cloud computing platform 20 in a respective designated destination (i.e., the verified destination of block 606). For example, the ingestion accelerator 22, using an ingestion pipeline 28, can run an automated script(s) to generate template files 32 from a pre-existing IDC in the intermediate landing zone storing the IDC. In example embodiments, the template files 32 are populated directly from the information received in block 602 (i.e., the template file 32 is a migrated IDC file (or portion thereof), where the IDC is copied from a home directory of the ingestion accelerator 22 to the ingestor 34 and/or template repository 30). Populating the template files 32 can, as alluded to above, provide a reference for the various parties interested in adjusting ingestion of the data files 25. In addition, populating the template files 32 via the automation of the ingestion accelerator 22 can ensure accuracy, as well as the timely creation of template files 32. Errors can be relatively quickly spotted given the existence of prior sequential steps to determine a target destination and/or ensure that it is been properly provisioned.

At block 612, the ingestion accelerator 22, with a pipeline 28, populates one or more configuration reference destinations (e.g., the metadata repository 36) for transforming raw data into a format compatible with the database 18b. Population of the configuration reference destinations can include the ingestion accelerator 22 generating, with a configuration generating pipeline, configuration files 38 based on the template files 32 populated in block 610, and storing generated configuration files 38 in the metadata repository 36. For example, the ingestion accelerator 22 can be used to extract data in a first format in the template file 32 and create a configuration file 38 for ingestion which performs the necessary transformations on any data files 25 ingested into another format (e.g., JSON). In example embodiments, block 612 includes populating an existing configuration file 38 into the configuration reference destination.

At block 614, the ingestion accelerator 22 validates the population of the configuration reference destination. The validation can include determining the existence of a provisioned configuration reference destination (e.g., an appropriate allocation of a location in the metadata repository 36 has been made) via the ingestor 34, and that the configuration reference destination is populated with at least one configuration file 38. In this way, the method shown in FIG. 6 provides a check that independently assesses different portions of configuring the ingestion process to assure accuracy, which is important in instances where large amounts of data are to be ingested. Similarly, block 614 provides an intermediate check to ensure that necessary provisioning steps for accelerating ingestion are present, before data is ingested. In at least some example embodiments, block 614 would not be arrived at without existing prerequisite steps (e.g., the population of the template file 32) being performed, however the existence of the prerequisite steps does not itself ensure accurate and timely ingestion. As the configuration files 38 may be used to speed up acceleration, ensuring these files are accurately provisioned and situated is not without challenges as users can be tempted to move them, to change them, etc.

At block 616, the ingestion accelerator 22 (e.g., via the ingestor 34), validates the creation of the template files 32. Validation can include a comparison of properties of the template file 32 with the one or more properties of a data source (e.g., database 18a) with the template file 32 properties to identify consistency. For example, the one or more properties of the data source can include a data format, a number of columns that the data files 25 related thereto will have, etc. In example embodiments, the validation of block 616 can include determining that the template file 32 exists, and that it is in an expected location.

At block 618, the ingestion accelerator 22 can perform a check of performed blocks to ensure consistency. The check can compare common properties in the template file 32, the configuration files 38, the target destination, etc., for inconsistency. For example, block 618 can include ensuring that a table name specified in the template files 32 correlates to the table made in the target destination.

Block 618 can respond to situations where entities which have stewardship over the different components of the ingestion process generate changes to their respective components. For example, a data scientist may make changes to the template files 32 in response to a change to how data is maintained in a database 18a. This change, which is performed independent of other components, can create a misalignment and failed ingestion. Block 618 can therefore be used to prevent individual actors in a multifactor architecture from impacting other components.

Block 618 can additionally include validating that the common properties are appropriately captured by the ingestion pipeline(s) 28. For example, different ingestion pipelines 28 can include tasks at least in part reliant on the common properties, and block 618 can automate reviewing of the pipeline(s) 28 to ensure that the tasks rely on, for example, the appropriate configuration file 38, rely on the appropriate target destination, etc.

At block 620, the ingestion pipeline 28 for ingesting the data files 25 into the database 18b is configured for ingestion (or provided therefor). Configuring for ingestion can include running a pipeline separate from the pipeline 28 for ingesting the data 25 (e.g., a configuration pipeline 28) to modify a status property of the ingestion pipeline 28. For example, the ingestion pipeline 28 for ingesting data can have a status designated as an active state from an inactive state, or paused state, where a paused state can include the pipeline 28 waiting for data files 25 to ingest.

At block 622, a confirmation pipeline 28 can be used to assess the status of the ingestion pipeline 28 of block 620. For example, the confirmation pipeline 28 can ensure that the status of the pipeline 28 is correctly set (e.g., set to paused) prior to moving data from the enterprise platform 16 to the landing zone 24 of the cloud computing platform 20. Absent block 622, ingestion failure can be difficult to diagnose, as it may be difficult to understand which data has been transferred from the enterprise platform 16 to the cloud computing platform 20, as the data files 25 will have been processed through the various ingestion phases (e.g., transformation), but are not stored in the database 18b.

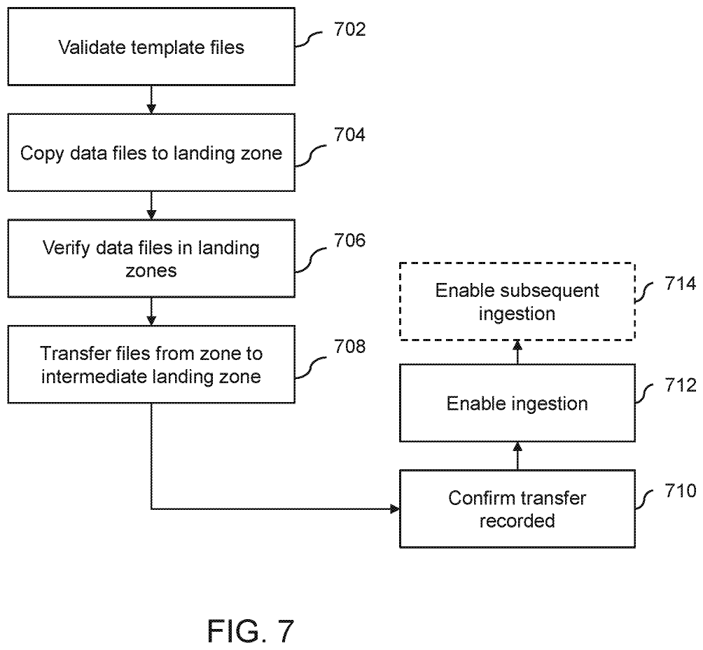

FIG. 7 shows a flow diagram of an example method performed by computer executable instructions for ingesting data from a data source according to the disclosure herein.

At block 702, the ingestion accelerator 22 (e.g., via the ingestor 34) validates the existence of template file 32 relevant to data files 25 to be ingested in the landing zone 24. This validation can include not only validating the existence of the template file 32, but also parsing through the template file 32 to ensure that it at least in part matches the data expected to be in data files 25. Block 702 can include determining an intermediate landing zone (e.g., a separate instance of the landing zone 24) to use to ingest data from the particular data source (e.g., a specific instance of the database 18a).

At block 704, based on the validated template file 32, the data files 25 are received in the landing zone 24.

At block 706, the ingestion accelerator 22 verifies that the data files 25 are in the landing zone 24. Validation can include the existence of the data file 25, and the validation of one or more parameters of the data files.

At block 708, the ingestion accelerator 22 (e.g., via the ingestor 34 and/or the ingestion pipeline 28) migrates the validated data files 25 in the landing zone 24, which can be a TIBCO™ landing zone, into an intermediate landing zone (e.g., a separate instance of the landing zone 24 designated for data files 25 from the validated data source). The migration can be accomplished by a separate pipeline 28.

At block 710, the ingestion accelerator 22 confirms that the verified data files 25 were migrated to the intermediate landing zone. In this way, data which is in some way corrupted, or incompletely migrated, is not provided to the ingestion pipeline 28 for ingestion. Moreover, the use of separate instances of landing zones 24 and pipelines 28 (which have been validated), can ensure not only accuracy of ingestion, but also enable robustness and scalability.

Block 710 can include referencing a watermark file used to track a plurality of ingestions into the cloud computing platform 20 to confirm various details associated with the data files 25 before ingestion. For example, block 710 can include confirming that the data files 25 originate from a data source registered with the watermark file (alternately referred to as a watermark table), are headed to the destination registered in the watermark table, confirm that configuration data of the data source associated with the data file 25 matches configuration data properties of the ingested data file 25, etc.

The watermark table can be more generally used for tracking composition of the target destination, or more generally for tracking data flow between the enterprise platform 16 and the cloud computing platform 20.

At block 712, the data files 25 in the intermediate landing zone, after verification, is provided to the ingestion pipeline 28 for ingestion. Ingestion can include transformations according to the configuration file 38, or other operations, to arrive at the target destination with the desired formatting.

Optionally, a block 714, additional data files from the data source of the already ingested data files 25 can be processed through the same process shown in FIG. 7. The additional data can be processed without additional verification, or partially verified (i.e., at least some blocks of FIG. 7 can be repeated), or with full verification. Additional data from the source can be designated for automatic processing according to FIG. 7. In at least some example embodiments, the subsequent data files ingested in block 714 are ingested in real time or near real time, automatically.

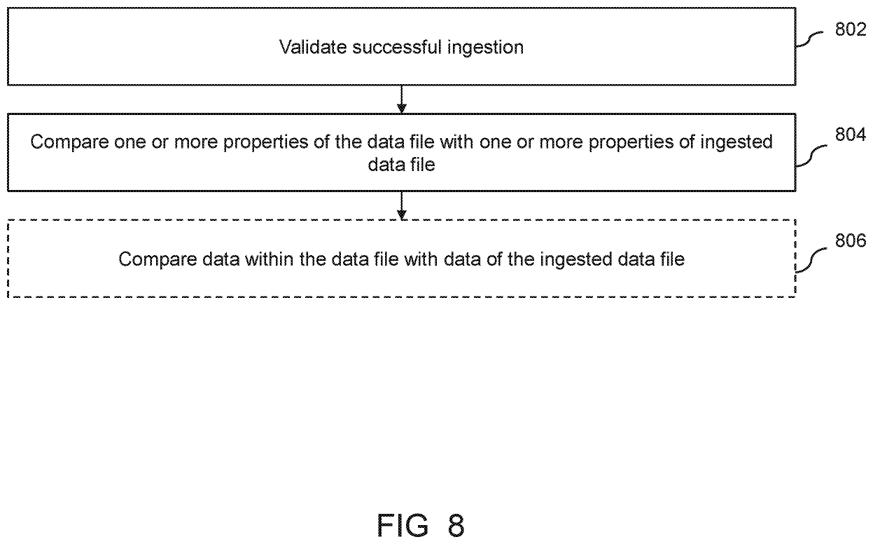

FIG. 8 shows a flow diagram of an example method performed by computer executable instructions for validating ingested data.

At block 802, the ingestion of the data files 25 can be verified by checking the watermark table to ensure that records associated with the ingestion are present and are accurate (e.g., data source is known, data destination is registered).

At block 804, the ingestion accelerator 22 can assess one or more properties of the ingested data files 25 to verify completed ingestion. For example, the one or more properties can include comparing a record count at the database 18a (e.g., data files 25 had a thousand columns in the data source) with the record count of the ingested data files 25.

A block 806, the properties of the ingested data file can be compared with existing data in the database 18b. For example, the ingested data can be checked to be temporally consistent (e.g., the data does not predate any stale data), to ensure that it is in the same format (e.g., there are no null entries), etc. in another example, the properties of the ingested data can be to derivative values based on other data in a database 18 a (e.g., a record count can be performed which compares record counts prior to the ingestion of the data file 25 and the record counts in the data source to the post ingestion data).

It is understood that one or more of the blocks described in respect to FIGS. 6 to 8 can be completed automatically. Furthermore, it is understood that references to the preceding figures in FIGS. 6 to 8 are illustrative and are not intended to be limiting. In addition, in instances where the validation or verification or comparison is not satisfied, it is understood that the ingestion process will be paused, or cancelled, until further input is received.

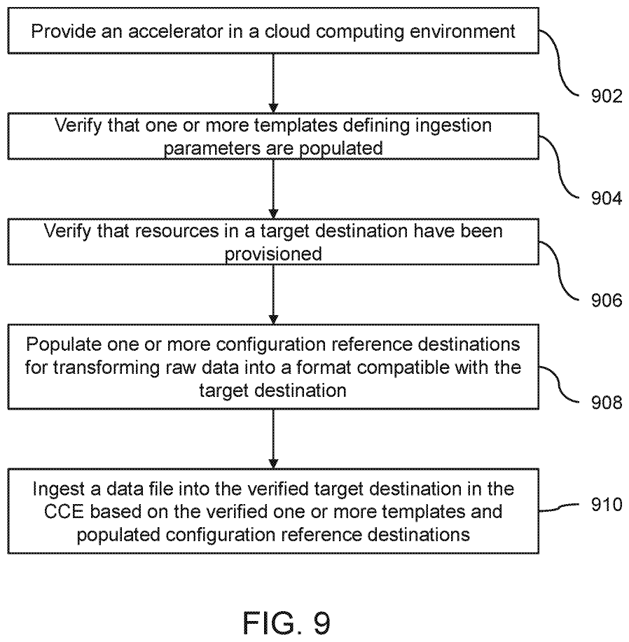

FIG. 9 shows a flow diagram of an example method performed by computer executable instructions for ingesting data onto cloud computing environments.

At block 902, the ingestion accelerator 22 is provided to the cloud computing platform 20.

A block 904, ingestion accelerator 22 automatically verifies that one or more templates defining ingestion parameters (e.g., the template files 32) are populated in the cloud computing platform 20.

At block 906, ingestion accelerator 22 automatically verifies that resources in the target destination (e.g., database 18b) have been provisioned.

The block 908, one or more configuration reference destinations are populated. The configuration reference destinations (e.g., metadata repository 36) can be populated with a generated configuration file 38, or with an existing configuration file 38, etc.

At block 910, a data file (e.g., data file 25) is ingested into the verified target destination in the cloud computing platform 20 based on the verifying one or more templates and the populated configuration reference destinations.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A system for ingesting data onto cloud computing environments, the system comprising:
a processor;
a communications module coupled to the processor; and
a memory coupled to the processor, the memory storing computer executable instructions that when executed by the processor cause the processor to:
provide an accelerator in a cloud computing environment for ingestion of data into the cloud computing environment;
automatically, with the accelerator:
verify that one or more templates defining ingestion parameters are populated on the cloud computing environment;
verify that resources in a target destination in the cloud computing environment have been provisioned;
populate, based on the one or more templates, and with a pipeline of tasks, one or more configuration reference destinations for transforming raw data into a format compatible with the provisioned target destination; and
ingest a data file into the verified target destination in the cloud computing environment based on the verified one or more templates and populated configuration reference destinations.

2. The system of claim 1, wherein the instructions cause the processor to:
compare one or more properties of a source database associated with the data file with properties in the one or more templates to identify inconsistency; and
in response to determining inconsistency, prevent ingestion of the data file via a pipeline.

3. The system of claim 1, wherein the instructions cause the processor to:
generate, with another pipeline, one or more configuration files for use during ingestion; and
populate for the configuration reference destinations with the generated one or more configuration files,
wherein ingestion of the data file into the target destination comprises one or more transformation steps defined by the generated one or more configuration files configuration files.

4. The system of claim 1, wherein the instructions cause the processor to validate that the target destination has correct access permissions to enable ingestion.

5. The system of claim 1, wherein the instructions cause the processor to:
provide an ingestion pipeline for ingesting the data file; and
confirm instantiation of the ingestion pipeline prior to ingesting the data file by changing a property of the pipeline.

6. The system of claim 5, wherein the instructions cause the processor to:
with a confirmation pipeline, compare the property of the pipeline to an expected property to assess whether the pipeline has been correctly instantiated.

7. The system of claim 1, wherein the instructions cause the processor to:
compare configuration data of a data source associated with the data file with configuration data of the ingested data file; and
in response to determining the respective configurations are consistent, enable ingestion of additional data files from the data source.

8. The system of claim 1, wherein the instructions cause the processor to automate ingestion of additional data files associated with the data file through the pipeline.

9. The system of claim 8, wherein the additional data files are ingested in real time.

10. The system of claim 1, wherein the data file arrives in a landing zone, and ingesting the data file into the destination resources in the cloud computing environment comprises the instructions to cause the processor to:
with a migration pipeline, migrate the data file into an intermediate landing zone associated with the target destination;
determine whether the migrated data file corresponds to a valid data source in a watermark table for tracking composition of the target destination; and
in response to determining the migrated data file corresponds with the watermark table, enable ingestion of the data file with a transport pipeline.

11. A method for ingesting data onto cloud computing environments, the method comprising:
providing an accelerator in a cloud computing environment for ingestion of data into the cloud computing environment;
automatically, with the accelerator:
verifying that one or more templates defining ingestion parameters are populated on the cloud computing environment;
verifying that resources in a target destination in the cloud computing environment have been provisioned;
populating, based on the one or more templates, and with a pipeline of tasks, one or more configuration reference destinations for transforming raw data into a format compatible with the provisioned target destination; and
ingesting a data file into the verified target destination in the cloud computing environment based on the verified one or more templates and populated configuration reference destinations.

12. The method of claim 11, comprising:
comparing configuration files in the configuration reference destinations with the templates to identify inconsistency; and
in response to determining inconsistency, preventing ingestion of the data file via a pipeline.

13. The method of claim 11, further comprising:
generating, with another pipeline, one or more configuration files for use during ingestion; and
populating for the configuration reference destinations with the generated one or more configuration files,
wherein ingestion of the data file into the target destination comprises one or more transformation steps defined by the generated one or more configuration files.

14. The method of claim 11, comprising:
providing an ingestion pipeline for ingesting the data file; and
confirming instantiation of the ingestion pipeline prior to ingesting the data file by changing a property of the pipeline.

15. The method of claim 14, further comprising, with a confirmation pipeline, comparing the property of the pipeline to an expected property to assess whether the pipeline has been correctly instantiated.

16. The method of claim 11, comprising:
comparing configuration data of a data source associated with the data file with configuration data of the ingested data file; and
in response to determining the respective configurations are consistent, enabling ingestion of additional data files from the data source.

17. The method of claim 11, further comprising automating ingestion of additional data files associated with the data file through the pipeline.

18. The method of claim 17, wherein the additional data files are ingested in real time.

19. The method of claim 11, wherein the data file arrives in a landing zone, and ingesting the data file into the destination resources in the cloud computing environment further comprises:
with a migration pipeline, migrating the data file into an intermediate landing zone associated with the target destination;
determining whether the migrated data file corresponds to a valid data source in a watermark table for tracking composition of the target destination; and
in response to determining the migrated data file corresponds with the watermark table, enabling ingestion of the data file with a transport pipeline.

20. A non-transitory computer readable medium for ingesting data onto cloud computing environments, the computer readable medium comprising computer executable instructions for:
providing an accelerator in a cloud computing environment for ingestion of data into the cloud computing environment;
automatically, with the accelerator:
verifying that one or more templates defining ingestion parameters are populated on the cloud computing environment;
verifying that resources in a target destination in the cloud computing environment have been provisioned;
populating, based on the one or more templates, and with a pipeline of tasks, one or more configuration reference destinations for transforming raw data into a format compatible with the provisioned target destination; and
ingesting a data file into the verified target destination in the cloud computing environment based on the verified one or more templates and populated configuration reference destinations.
